(19) United States
(12) Patent Application Publication
(10) Pub. No.: US 2012/0259985 A1
(43) Pub. Date: Oct. 11, 2012

(54) METHOD AND APPARATUS FOR ENABLING WIRELESS CONNECTIVITY

(75) Inventors: Timo Koskela, Oulu (FI); Sami Hakola, Kempele (FI); Samuli Turtinen, Ii (FI)

(73) Assignee: Renesas Mobile Corporation

(21) Appl. No.: 13/083,109

(22) Filed: Apr. 8, 2011

(51) Int. Cl. G06F 15/16

(52) U.S. Cl. 709/227

(57) ABSTRACT

A method for providing improved wireless connectivity for wireless devices operating in a heterogeneous multi-RAT environment may include receiving, at a network device, information indicative of one or more radio access technologies detected by a user equipment (UE) in corresponding locations where the received information is received in connection with a session initiation protocol (SIP) procedure, and causing provision of the received information to an access network discovery and selection function (ANDSF). A corresponding apparatus and computer program product are also provided.

### TECHNOLOGICAL FIELD

Embodiments of the present invention relate generally to connectivity enhancements for wireless devices and, more particularly, relate to a method, apparatus and computer program product for providing improved wireless connectivity for wireless devices operating in a heterogeneous multiple radio access technology (multi-RAT) environment.

### BACKGROUND

Session setups for future wireless networks such as long term evolution-advanced (LTE-A),are envisioned to be performed using session initiation protocol (SIP) operating on transmission control protocol (TCP) or user datagram protocol (UDP) transport layer protocols. In this regard, a SIP user agent typically interacts with a SIP proxy located in the user agent's home network. In Internet protocol multimedia services subsystem (IMS), a proxy call state control function (P-CSCF) is typically the closest IMS node with which a user equipment (UE) or other mobile terminal interacts. Thus, the P-CSCF often acts as the SIP proxy for the UE. In a SIP registration phase, the UE may be enabled to indicate its access network information such as the RAT type and cell ID to its SIP proxy.

The Third Generation Partnership Project (3GPP) has specified (e.g., in Rel8) an access network discovery and selection function (ANDSF) as an entity in a layer 3 protocol that allows operators to provide inter-system mobility policies. With provided policies, the ANDSF may enable devices to select the most suitable access network of different access network technologies (e.g., wireless local area network (WLAN), WiMAX and/or the like) that are available in the area. However, only the interface between the UE and the ANDSF has currently been defined without much information as to how the ANDSF is to work internally. Thus, the ANDSF does not have any defined connection to other network entities.

In relation to the interaction between the UE and the ANDSF, the UE typically requests available information from the ANDSF with a frequency that depends upon implementation characteristics. However, the UE typically does not provide any information back to the ANDSF about its environment. This may leave the ANDSF unable, or at least substantially limited in its ability to gather information about available access networks. Accordingly, it may be desirable to improve the ability of the environment of the UE to be known by the ANDSF.

### BRIEF SUMMARY OF EXAMPLE EMBODIMENTS

A method, apparatus and computer program product are therefore provided to enable improved wireless connectivity for wireless devices operating in a heterogeneous multi-RAT environment. In this regard, in some example embodiments, a mechanism is provided for enabling improved initialization of interface with the ANDSF. Some example embodiments may also, or alternatively, enable information on available RATs for the UE to be provided to the ANDSF.

In an example embodiment, a method of providing improved wireless connectivity for wireless devices operating in a heterogeneous multi-RAT environment is provided. The method may include receiving, at a network device, information indicative of one or more radio access technologies detected by a user equipment (UE) in corresponding locations where the received information is received in connection with a session initiation protocol (SIP) procedure, and causing provision of the received information to an access network discovery and selection function (ANDSF).

In another example embodiment, an apparatus for providing improved wireless connectivity for wireless devices operating in a heterogeneous multi-RAT environment is provided. The apparatus may include processing circuitry configured to perform at least receiving, at a network device, information indicative of one or more radio access technologies detected by a user equipment (UE) in corresponding locations where the received information is received in connection with a session initiation protocol (SIP) procedure, and causing provision of the received information to an access network discovery and selection function (ANDSF).

In one example embodiment, a computer program product for providing improved wireless connectivity for wireless devices operating in a heterogeneous multi-RAT environment is provided. The computer program product may include at least one computer-readable storage medium having computer-executable program code instructions stored therein. The computer-executable program code instructions may include program code instructions for receiving, at a network device, information indicative of one or more radio access technologies detected by a user equipment (UE) in corresponding locations where the received information is received in connection with a session initiation protocol (SIP) procedure, and causing provision of the received information to an access network discovery and selection function (ANDSF).

In one example embodiment, a method of providing improved wireless connectivity for wireless devices operating in a heterogeneous multi-RAT environment from the perspective of an ANSDF is provided. The method may include receiving, from a network device in an Internet protocol multimedia services subsystem (IMS) layer, information indicative of one or more radio access technologies detected by a user equipment (UE) in corresponding locations where the network device has received the information in connection with a session initiation protocol (SIP) procedure. The method further includes causing generation of a coverage map based on the information.

In another example embodiment, an apparatus for providing improved wireless connectivity for wireless devices operating in a heterogeneous multi-RAT environment from the perspective of an ANSDF is provided. The apparatus may include processing circuitry configured to perform at least receiving, from a network device in an Internet protocol multimedia services subsystem (IMS) layer, information indicative of one or more radio access technologies detected by a user equipment (UE) in corresponding locations where the network device has received the information in connection with a session initiation protocol (SIP) procedure. The processing circuitry may further be configured to cause generation of a coverage map based on the information.

In one example embodiment, a computer program product for providing improved wireless connectivity for wireless devices operating in a heterogeneous multi-RAT environment from the perspective of an ANSDF is provided. The computer program product may include at least one computer-readable storage medium having computer-executable program code instructions stored therein. The computer-executable program code instructions may include program code instructions for receiving, from a network device in an Internet protocol multimedia services subsystem (IMS) layer, information indicative of one or more radio access technologies detected by a user equipment (UE) in corresponding locations where the network device has received the information in connection with a session initiation protocol (SIP) procedure. The program code instructions may further cause generation of a coverage map based on the information.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates one example of a communication system according to an example embodiment of the present invention;

FIG. 2 illustrates a block diagram of IMS according to an example embodiment;

FIG. 3 illustrates a block diagram showing an apparatus for providing improved wireless connectivity for wireless devices operating in a heterogeneous multi-RAT environment in accordance with an example embodiment of the present invention;

FIG. 4 illustrates a block diagram showing an apparatus for providing improved wireless connectivity for wireless devices operating in a heterogeneous multi-RAT environment from the perspective of the ANDSF in accordance with an example embodiment of the present invention

FIG. 5 illustrates a flowchart of a method of providing improved wireless connectivity for wireless devices operating in a heterogeneous multi-RAT environment in accordance with an example embodiment of the present invention; and

FIG. 6 illustrates a flowchart of a method of providing improved wireless connectivity for wireless devices operating in a heterogeneous multi-RAT environment from the perspective of an ANDSF in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, the ability of the ANDSF to gather information about available access networks has typically been limited to gathering such information via communication with a UE itself. Previously, the availability of access networks has been considered to be relatively static per certain location. However, when LTE and/or LTE-A are extended to be deployed onto unlicensed shared spectrum, more dynamic behavior of access networks' availability per certain area is expected. Some example embodiments of the present invention may enable the provision of information about the UE's vicinity (e.g., RAT's it can detect) to the ANDSF. However, since SIP is a main session setup signaling protocol, the use of certain notifications via SIP to network entities are already in place. Thus, if the UE simply directly provided information to the ANDSF, there would be some redundant, and therefore inefficient, signaling that would waste both UE and network resources. Accordingly, some example embodiment may provide a mechanism by which to utilize SIP signaling between the UE and the SIP proxy (e.g., for SIP registration procedure or other SIP procedure-related communications) to provide an indication regarding information about RATs and/or access points that the UE detects in corresponding areas. The detected RATs may then be mapped to a reference identifier (or reference ID) of a corresponding RAT or access point that may provide needed reference information for the ANDSF to create a coverage map. As an example, in a 3GPP scenario, the SIP message may include the current RAT (e.g., GSM, 3G, LTE, and/or the like) and the technology specific identifier such as the cell ID.

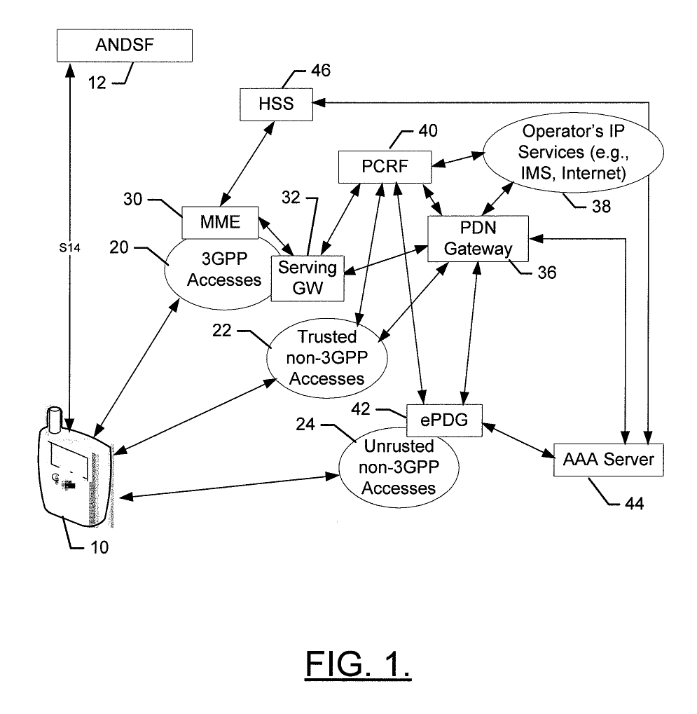

FIG. 1 illustrates a generic system diagram in which a device such as a mobile terminal (or UE 10), is shown in an example communication environment in which embodiments of the present invention may be employed. As such, FIG. 1 illustrates a typical network architecture and S14 interface between a UE and ANDSF according to an example embodiment. As shown in FIG. 1, the UE 10 may be in communication with an ANDSF 12 via an S14 interface. The UE 10 may also be capable of communication with various network access points associated with different access networks. For example, the UE 10 may be capable of communication with 3GPP accesses 20, trusted non-3GPP accesses 22, and untrusted non-3GPP accesses 24. A mobile management entity (MME) 30 may handle UE 10 tracking and paging and may provide control plane functions for mobility between 3GPP access networks. A serving gateway (GW) 32 may route and forward user data packets, while also acting as a mobility anchor to support UE mobility. The packet data network (PDN) gateway 36 may provide connectivity from the UE 10 to external packet data networks and operator IP services 38 associated therewith (e.g., the Internet or IMS by being the point of exit and entry of traffic for the UE 10 via any of the accesses (20, 22 or 24)).

The policy charging and rules function (PCRF) 40 may determine policy rules in the multimedia network by supporting the creation of rules and then automatically making intelligent policy decisions for each subscriber active on the network. The evolved packet data gateway (ePDG) 42 may provide interworking between the evolved packet core (EPC) and untrusted non-3GPP networks that require secure access, such as a WiFi, femtocell access networks and/or the like. An AAA server 44 may be provided to perform authentication, authorization and accounting (AAA) services. Meanwhile, the home subscriber service (HSS) 46 may maintain a collection of service and user data in service profiles that define public user identities that may be associated with private user identities that are associated with IMS subscriptions.

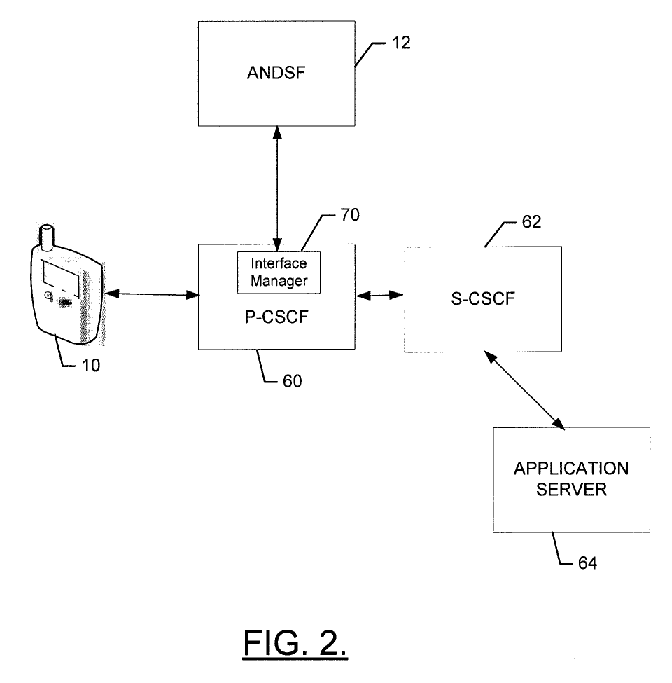

The ANDSF 12 is configured to provide information to the UE 10 about connectivity to 3GPP and non-3GPP access networks (such as Wi-Fi and/or the like) in order to assist the UE 10 in discovering the access networks in the vicinity of the UE 10 and to provide rules or policies to prioritize and manage connections to these networks. As can be seen from FIG. 1, the ANDSF 12 typically has limited interface with other network entities. In an example embodiment, an interface may be defined between the ANDSF 12 and other network entities via a SIP proxy. For example, as shown in FIG. 2, an interface may be defined between the ANDSF 12 and a P-CSCF 60. The interface may therefore be between the ANDSF 12 and a network device of the IMS layer (e.g., the P-CSCF 60).

FIG. 2 illustrates a block diagram of IMS according to an example embodiment. As shown in FIG. 2, the IMS may include UE 10, P-CSCF 60, a serving-CSCF (S-CSCF) 62, and the ANDSF 12. As is shown in FIG. 2, the UE 10 may be in communication with the P-CSCF 60, which may also communicate with the S-CSCF 62. The P-CSCF 60 and the S-CSCF 62 may each be network devices of the IMS layer. The S-CSCF 62 may be located in the home network and may be configured to perform session control functions. Although not shown in FIG. 2, the S-CSCF 62 may be in communication with the I-ISS 46. Moreover, the S-SCSF 62 may provide communication to one or more application servers 64. The application servers 64 may be located in a service or application layer and may be configured to host and execute services.

In an example embodiment, the P-CSCF 60 may also be in communication with the ANDSF 12 via an interface that is managed by interface manager 70. The interface manager 70 may act as, or may be a component of, an apparatus for providing information indicative of detected RATs at the UE 10 to the ANDSF 12 via the interface defined between the P-CSCF 60 and the ANDSF 12. The P-CSCF 60 may receive information from the UE 10 during typical SIP registration or other SIP procedures and may pass selected portions of that information on to the ANDSF 12. Accordingly, information about RATs and/or access points that the UE detects in corresponding areas may be provided to the ANDSF 12 without redundant or inefficient signaling directly from the UE 10 to the ANDSF 12, or indirectly to the ANDSF 12 using additional or redundant signaling.

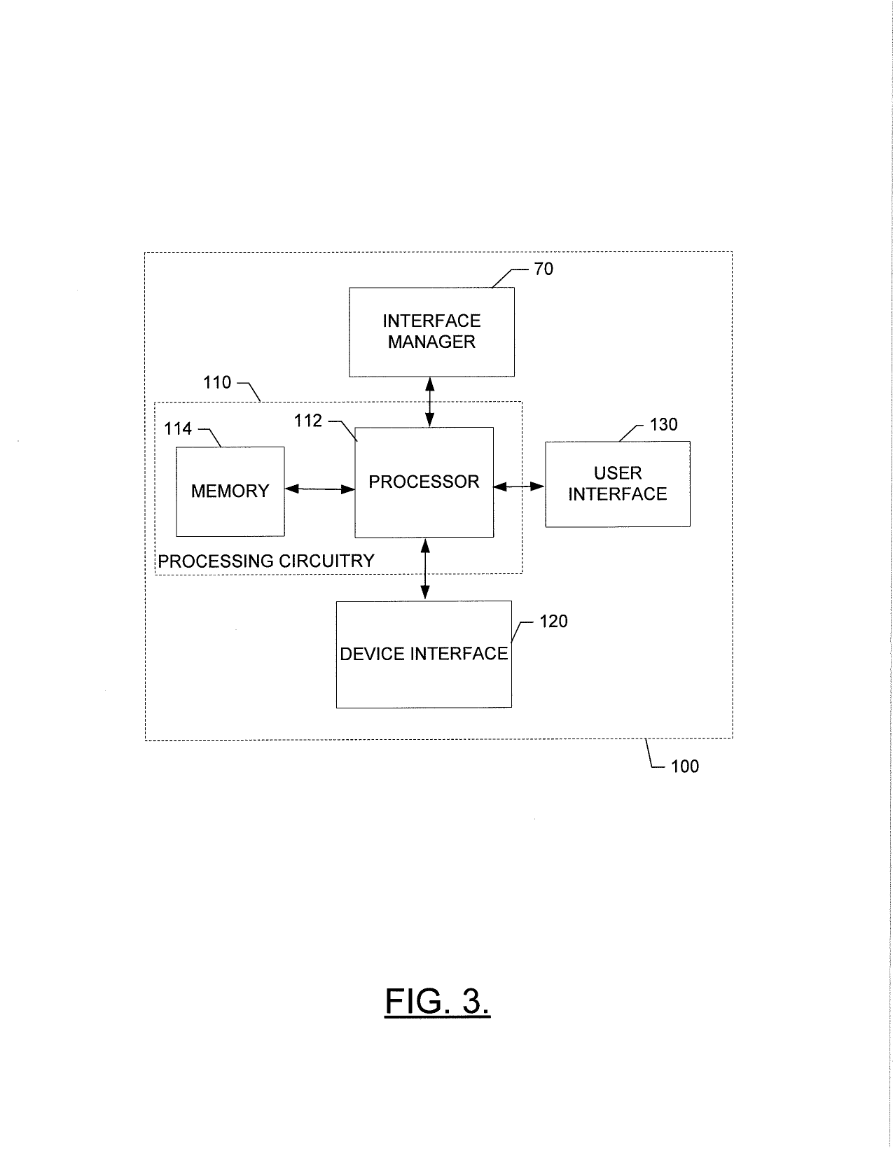

FIG. 3 illustrates an example apparatus 100 in which the interface manager 70 may form a component in accordance with an example embodiment. An example embodiment of the invention will now be described with reference to FIG. 3, in which certain elements of an apparatus 100 for providing improved wireless connectivity for wireless devices operating in a heterogeneous multi-RAT environment are displayed. The apparatus 100 of FIG. 3 may be employed, for example, on the P-CSCF 60 or a variety of other communication devices located in the IMS layer. However, it should be noted that the components, devices or elements described below may not be mandatory and thus some may be omitted in certain embodiments. Additionally, some embodiments may include further or different components, devices or elements beyond those shown and described herein.

Referring now to FIG. 3, the apparatus 100 may include or otherwise be in communication with processing circuitry 110 that is configurable to perform actions in accordance with example embodiments described herein. The processing circuitry 110 may be configured to perform data processing, application execution and/or other processing and management services according to an example embodiment of the present invention. In some embodiments, the apparatus 100 or the processing circuitry 110 may be embodied as a chip or chip set. In other words, the apparatus 100 or the processing circuitry 110 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 100 or the processing circuitry 110 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 110 may include a processor 112 and memory 114 that may be in communication with or otherwise control a device interface 120 and, in some cases, a user interface 130. As such, the processing circuitry 110 may be embodied as a circuit chip (e.g., an integrated circuit chip) configured (e.g., with hardware, software or a combination of hardware and software) to perform operations described herein. However, in some embodiments, the processing circuitry 110 may be embodied as a portion of a server, computer, workstation or other fixed or mobile computing device. In situations where the processing circuitry 110 is embodied as a server or at a remotely located computing device, the user interface 130 may be disposed at another device (e.g., at a computer terminal or client device) that may be in communication with the processing circuitry 110 via the device interface 120 and/or a network.

The user interface 130 (if implemented) may be in communication with the processing circuitry 110 to receive an indication of a user input at the user interface 130 and/or to provide an audible, visual, mechanical or other output to the user. As such, the user interface 130 may include, for example, a keyboard, a mouse, a joystick, a display, a touch screen, a microphone, a speaker, and/or other input/output mechanisms. In an exemplary embodiment in which the apparatus is embodied at a server or other network device (e.g., the P-CSCF 60), the user interface 130 may be fully implemented, limited, remotely located or eliminated.

The device interface 120 may include one or more interface mechanisms for enabling communication with other devices and/or networks. In some cases, the device interface 120 may be any means such as a device or circuitry embodied in either hardware, or a combination of hardware and software that is configured to receive and/or transmit data from/to a network and/or any other device or module in communication with the processing circuitry 110. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an exemplary embodiment, the memory 114 may include one or more non-transitory memory devices such as, for example, volatile and/or non-volatile memory that may be either fixed or removable. The memory 114 may be configured to store information, data, applications, instructions or the like for enabling the apparatus 100 to carry out various functions in accordance with exemplary embodiments of the present invention. For example, the memory 114 could be configured to buffer input data for processing by the processor 112. Additionally or alternatively, the memory 114 could be configured to store instructions for execution by the processor 112. As yet another alternative, the memory 114 may include one of a plurality of databases that may store a variety of files, contents or data sets. Among the contents of the memory 114, applications may be stored for execution by the processor 112 in order to carry out the functionality associated with each respective application. In some cases, the memory 114 may be in communication with the processor 112 via a bus for passing information among components of the apparatus 100.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform the operations described herein.

In an example embodiment, the processor 112 (or the processing circuitry 110) may be embodied as, include or otherwise control the interface manager 70. The interface manager 70 may be configured to receive information from the UE 10 that is indicative of the RATs that the UE 10 can detect in one or more corresponding areas. The detected RATs may be mapped to corresponding reference identifiers of a certain RAT or access point. The reference identifiers may provide the needed information for the ANDSF 12 to generate a coverage map. For example, SIP messages provided to the interface manager 70 may indicate a cell ID, base station ID or other indicator of the RAT or access point with which the UE 10 can communicate in a given area. Other RATs that the UE 10 has detected while connected to a current RAT and corresponding RAT-specific identifiers may be mapped together. For example, if the current RAT is LTE, the cell ID may be provided as ‘cell-id-info’. Meanwhile, if an associated RAT or access point is an LTE-femto or a home nodeB, the cell ID may be provided as ‘cell-id-info’. If the associated RAT or access point is a WLAN-access point (AP), the base station ID (BSSID) may be provided as ‘48 bit identifier/addresss’.

Since it can be assumed that SIP messages are typically used for application layer control signaling by the UE 10 with various applications running in the UE 10, the RAT information may be conveyed on the messages until the SIP proxy (e.g., the P-CSCF 60). Then, a logical interface between the SIP proxy and the ANDSF 12 may convey the RAT information gathered by the SIP proxy (e.g,. via the interface manager 70) so that the ANDSF 12 may ultimately be enabled to generate a coverage map for an operating area.

Thus, according to an example embodiment, the P-CSCF 60 may be configured to forward SIP register requests received from the UE 10 to an entry point determined using the home domain name, as provided by the UE 10. The P-CSCF 60 may also be configured to forward SIP messages received from the UE 10 to the SIP server (e.g., the S-CSCF 62) that is named as a result of the registration procedure. The P-CSCF 60 may also be configured to ensure that the SIP messages received from the UE 10 to be sent to the SIP server include the correct or up to date information about the access network type currently used by the UE 10, when the information is available from the access network. Depending on operator policies, the P-CSCF 60 may also insert the access network type currently used by the UE 10 in any SIP messages (e.g., requests or responses), when the information is available from the access network. The P-CSCF 60 may also be configured to forward SIP requests or responses to the UE 10, detect and handle an emergency session establishment request, generate CDRs, and maintain a security association between the P-CSCF 60 and each UE. In some embodiments, the P-CSCF 60 may also be configured to perform SIP message compression and/or decompression along with authorization of bearer resources and quality of service (QoS) management and detection and handling of an originating or terminating IMS MPS session establishment request. In some embodiments, the P-CSCF 60 may further be configured, via the interface manager 70, to initialize an interface with the ANDSF 12 and forward UE RAT information incorporated into SIP messages by the UE 10 to the ANDSF 12.

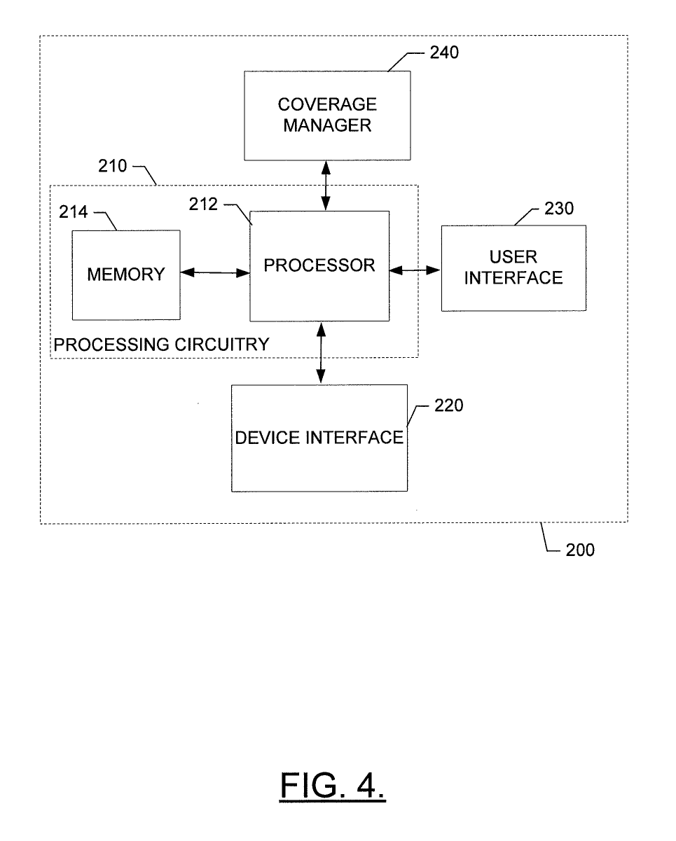

In another example embodiment, the ANDSF 12 may be configured to include or otherwise employ an apparatus according to an example embodiment of the present invention. FIG. 4 illustrates a schematic block diagram of an apparatus for providing improved wireless connectivity for wireless devices operating in a heterogeneous multi-RAT environment from the perspective of the ANDSF according to an example embodiment of the present invention from the perspective of the ANDSF 12. An example embodiment of the invention will now be described with reference to FIG. 4, in which certain elements of an apparatus 200 for providing improved wireless connectivity for wireless devices operating in a heterogeneous multi-RAT environment from the perspective of an ANDSF are displayed. The apparatus 200 of FIG. 4 may be employed, for example, on the ANDSF 12 or a variety of other communication devices. However, it should be noted that the components, devices or elements described below may not be mandatory and thus some may be omitted in certain embodiments. Additionally, some embodiments may include further components, devices or elements beyond those shown and described herein.

Referring now to FIG. 4, the apparatus 200 may include or otherwise be in communication with processing circuitry 210 that is configurable to perform actions in accordance with example embodiments described herein. The processing circuitry 210 may be configured to perform data processing, application execution and/or other processing and management services according to an exemplary embodiment of the present invention. In some embodiments, the apparatus 200 or the processing circuitry 210 may be embodied as a chip or chip set. In other words, the apparatus 200 or the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 210 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 210 may include a processor 212 and memory 214 that may be in communication with or otherwise control a device interface 220 and, in some cases, a user interface 230. The processor 212, memory 214, device interface 220 and user interface 230 may be substantially similar in function and basic structure (with perhaps semantic and/or scale differences in some cases) to the descriptions provided above for the processor 112, the memory 114, device interface 120 and user interface 130. Thus, descriptions of these components will not be repeated.

In an exemplary embodiment, the processor 212 (or the processing circuitry 210) may be embodied as, include or otherwise control a coverage manager 240. The coverage manager 240 may be configured to receive (e.g., from the P-CSCF 60) information indicative of one or more radio access technologies detected by the UE 10 in corresponding locations. The coverage manager 240 may be further configured to cause generation of a coverage map based on the information. The information may be provided via an interface between the ANDSF 12 and the P-CSCF 60 via the interface manager 70.

By employing the procedures described above, the ANDSF 12 may be enabled to be informed of the RATs that the UE 10 can detect in each area and generate a coverage map. However, the information can be provided to the ANDSF 12 without increasing redundancy or inefficiency in signaling by sending the information to the ANDSF 12 via the P-CSCF 60 which already receives some of the information in connection with SIP procedures.

Accordingly, network efficiency may be enhanced at the same time that wireless connectivity is improved.

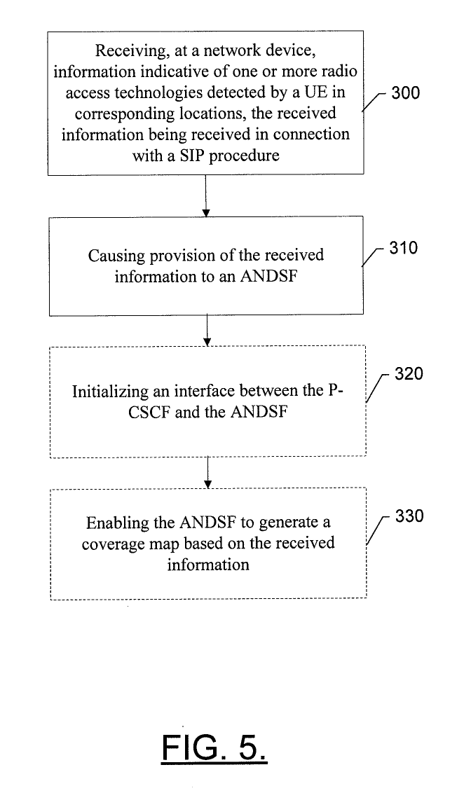

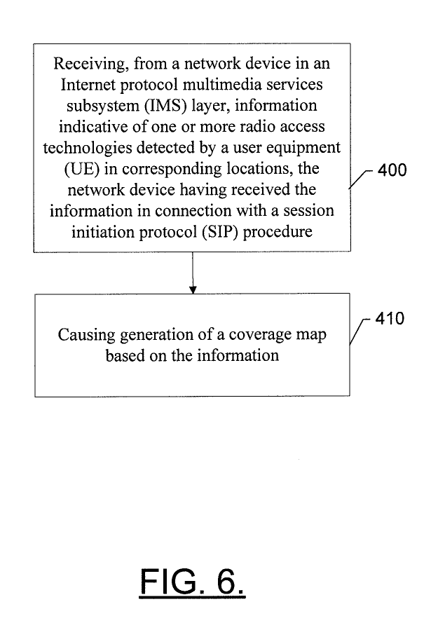

FIGS. 5 and 6 are flowcharts of a system, method and program product according to example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts block(s). These computer program instructions may also be stored in a non-transitory computer-readable storage memory that may direct a computer or other programmable apparatus to function in a particular manner, such that the instructions stored in the computer-readable storage memory produce an article of manufacture the execution of which implements the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In this regard, one embodiment of a method for providing improved wireless connectivity for wireless devices operating in a heterogeneous multi-RAT environment from the perspective of a network side entity in the IMS layer (e.g., the P-CSCF 60), as shown in FIG. 5, includes receiving, at a network device, information indicative of one or more radio access technologies detected by a user equipment (UE) in corresponding locations at operation 300. The received information may be received in connection with a SIP procedure. The method may further include causing provision of the received information to an ANDSF at operation 310.

In some embodiments, certain ones of the operations above may be modified or further amplified as described below. Moreover, in some embodiments additional optional operations may also be included (some examples of which is shown in dashed lines in FIG. 5). It should be appreciated that each of the modifications, optional additions or amplifications below may be included with the operations above either alone or in combination with any others among the features described herein. In an example embodiment, in which the network device is a P-CSCF, the method may further include initializing an interface between the P-CSCF and the ANDSF at operation 320. In some embodiments, the method may further include enabling the ANDSF to generate a coverage map based on the received information at operation 330. In an example embodiment, the network device may be a SIP proxy in an IMS layer. In some embodiments, causing provision of the received information may include providing an identifier of an access point and information indicative of a type of access network with which the access point is associated.

In an example embodiment, an apparatus for performing the method of FIG. 5 above may comprise a processing circuitry (e.g., processing circuitry 110) configured to perform some or each of the operations (300-330) described above, with or without some or all of the modifications described above. The processing circuitry 110 may, for example, be configured to perform the operations (300-330) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-330 may comprise, for example, the interface manager 70. Additionally or alternatively, at least by virtue of the fact that the processing circuitry 110 may be configured to control or even be embodied as the interface manager 70, the processing circuitry 110 and/or a device or circuitry for executing instructions or executing an algorithm for processing information as described above may also form example means for performing operations 300-330.

Another embodiment of a method for providing improved wireless connectivity for wireless devices operating in a heterogeneous multi-RAT environment from the perspective of an ANDSF, as shown in FIG. 6, includes receiving, from a network device in an IMS layer, information indicative of one or more radio access technologies detected by a UE in corresponding locations at operation 400. The network device may have received the information in connection with a SIP procedure. The method may further include causing generation of a coverage map based on the information at operation 410.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In an example embodiment, the network device may be a SIP proxy in an IMS layer. In some embodiments, causing generation of the coverage map may include causing generation of the coverage map at the ANDSF.

In an example embodiment, an apparatus for performing the method of FIG. 6 above may comprise a processing circuitry (e.g., processing circuitry 210) configured to perform some or each of the operations (400-410) described above, with or without some or all of the modifications described above. The processing circuitry 210 may, for example, be configured to perform the operations (400-410) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-410 may comprise, for example, the coverage manager 240. Additionally or alternatively, at least by virtue of the fact that the processing circuitry 210 may be configured to control or even be embodied as the coverage manager 240, the processing circuitry 210 and/or a device or circuitry for executing instructions or executing an algorithm for processing information as described above may also form example means for performing operations 400-410.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, at a network device, information indicative of one or more radio access technologies detected by a user equipment (UE) in corresponding locations, the received information being received in connection with a session initiation protocol (SIP) procedure; and
causing provision of the received information to an access network discovery and selection function (ANDSF).

2. The method of claim 1, wherein the network device comprises a SIP proxy in an Internet protocol multimedia services subsystem (IMS) layer.

3. The method of claim 1, wherein the network device comprises a proxy call state control function (P-CSCF) and the method further comprises initializing an interface between the P-CSCF and the ANDSF.

4. The method of claim 1, further comprising enabling the ANDSF to generate a coverage map based on the received information.

5. The method of claim 1, wherein causing provision of the received information comprises providing an identifier of an access point and information indicative of a type of access network with which the access point is associated.

6. An apparatus comprising processing circuitry configured to perform at least:
receiving, at a network device, information indicative of one or more radio access technologies detected by a user equipment (UE) in corresponding locations, the received information being received in connection with a session initiation protocol (SIP) procedure; and
causing provision of the received information to an access network discovery and selection function (ANDSF).

7. The apparatus of claim 6, wherein the network device comprises a SIP proxy in an Internet protocol multimedia services subsystem (IMS) layer.

8. The apparatus of claim 6, wherein the network device comprises a proxy call state control function (P-CSCF) and wherein the processing circuitry is further configured to initialize an interface between the P-CSCF and the ANDSF.

9. The apparatus of claim 6, wherein the processing circuitry is further configured to enable the ANDSF to generate a coverage map based on the received information.

10. The apparatus of claim 6, wherein the processing circuitry being configured to cause provision of the received information comprises the processing circuitry being configured to provide an identifier of an access point and information indicative of a type of access network with which the access point is associated.

11. A computer program product comprising at least one computer-readable storage medium having computer-executable program code instructions stored therein, the computer-executable program code instructions comprising program code instructions for:
receiving, at a network device, information indicative of one or more radio access technologies detected by a user equipment (UE) in corresponding locations, the received information being received in connection with a session initiation protocol (SIP) procedure; and
causing provision of the received information to an access network discovery and selection function (ANDSF).

12. The computer program product of claim 11, wherein the network device comprises a SIP proxy in an Internet protocol multimedia services subsystem (IMS) layer.

13. The computer program product of claim 11, wherein the network device comprises a proxy call state control function (P-CSCF) and wherein the computer program product further comprises program code instructions for initializing an interface between the P-CSCF and the ANDSF.

14. The computer program product of claim 11, further comprising program code instructions for enabling the ANDSF to generate a coverage map based on the received information.

15. The computer program product of claim 11, wherein program code instructions for causing provision of the received information include instructions for providing an identifier of an access point and information indicative of a type of access network with which the access point is associated.

16. A method comprising:
receiving, from a network device in an Internet protocol multimedia services subsystem (IMS) layer, information indicative of one or more radio access technologies detected by a user equipment (UE) in corresponding locations, the network device having received the information in connection with a session initiation protocol (SIP) procedure; and
causing generation of a coverage map based on the information.

17. The method of claim 16, wherein the network device comprises a SIP proxy in an Internet protocol multimedia services subsystem (IMS) layer.

18. The method of claim 16, wherein causing generation of the coverage map comprises causing generation of the coverage map at an access network discovery and selection function (ANDSF).

19. An apparatus comprising processing circuitry configured to perform at least:
receiving, from a network device in an Internet protocol multimedia services subsystem (IMS) layer, information indicative of one or more radio access technologies detected by a user equipment (UE) in corresponding locations, the network device having received the information in connection with a session initiation protocol (SIP) procedure; and
causing generation of a coverage map based on the information.

20. The apparatus of claim 19, wherein the network device comprises a SIP proxy in an Internet protocol multimedia services subsystem (IMS) layer.

21. The apparatus of claim 19, wherein the processing circuitry being configured to cause generation of the coverage map comprises the processing circuitry being configured to cause generation of the coverage map at an access network discovery and selection function (ANDSF).
